(19) United States
(12) Patent Application Publication
(10) Pub. No.: US 2015/0126240 A1
(43) Pub. Date: May 7, 2015

(54) METHOD AND APPARATUS FOR CONTROLLING COMMUNICATION POWER

(71) Applicant: Samsung Electronics Co., Ltd., Gyeonggi-do (KR)

(72) Inventor: Younghoon SUH, Gyeonggi-do (KR)

(21) Appl. No.: 14/531,176

(22) Filed: Nov. 3, 2014

(30) Foreign Application Priority Data
Nov. 6, 2013 (KR) 10-2013-0134079

(51) Int. Cl. H04W 52/18; H04B 1/38

(52) U.S. Cl. CPC H04W 52/18; H04B 1/3838
USPC 455/522

(57) ABSTRACT

A method and apparatus for controlling communication power which is capable of reducing a Specific Absorption Rate (SAR) using a touch screen when an electronic device performs communication.

### CLAIM OF PRIORITY

This application claims the benefit of priority under 35 U.S.C. §119(a) from a Korean patent application filed on Nov. 6, 2013 in the Korean Intellectual Property Office and assigned Serial No. 10-2013-0134079, the entire disclosure of which is hereby incorporated by reference in its entirety.

### BACKGROUND

1. Field of the Invention

The present disclosure relates to a method and apparatus for controlling communication power used by an electronic device. More particularly, the present disclosure relates to a method and apparatus for controlling communication power being capable of reducing a Specific Absorption Rate (SAR) generated by an electronic device.

2. Description of the Related Art

As a variety of types of electronic devices have recently come into wide use, electronic devices such as mobile terminals are now considered a necessity of modern life. The mobile terminal is popular because it maintains mobility and can provide various types of user functions, for example, mobile communication functions and game functions.

As more and more people are using mobile terminals, there is an increased interest regarding the influence on the human body of electromagnetic fields associated with the RF of the mobile terminal. Virtually all nations regulate the Specific Absorption Rate (SAR), which is a measure of the rate at which energy is absorbed by the human body. The regulation of SAR is out of concern that excessive levels of SAR emitted by the mobile terminal may have harmful effects on the human body. SAR for the mobile terminal is limited to 2.0 W/kg (i.e., an energy ratio per unit mass that is absorbed by a living tissue) in Europe and Japan. However, the U.S.A, Australia, and Canada adopt 1.6 W/Kg as a standard level of SAR.

In an existing technology, there is known a method of reducing the amount of radio waves emitted to the front part of an antenna that is mounted on a mobile terminal in order to reduce SAR. Furthermore, another existing technology adopts a method of reducing the amount of radio waves emitted using a grip sensor mounted on a mobile terminal depending on the degree that a user grasps the mobile terminal.

However, the aforementioned existing technologies are unable to be used in tablet PCs or mobile terminals of a specific size or higher because they are inevitably limited by the size of the antenna. Accordingly, there is a need a new technology in which the mobile terminal complies with the SAR standards and yet guarantees proper communication performance.

### SUMMARY

An aspect of the present disclosure provides a method and apparatus capable of removing noise generated by an electronic device.

In accordance with an aspect of the present disclosure, a method for controlling communication power in an electronic device includes checking whether or not a request signal for communication information is present, determining whether or not the amount of charges received by a touch screen is less than or greater than a predetermined threshold, and if the request signal for the communication information is found to be present, controlling power supplied to at least one of a wireless communication unit and transmission and reception power for the communication information based on a result of the determination of the amount of charges received by a touch screen.

In accordance with another aspect of the present disclosure, a method for controlling communication power in an electronic device includes checking whether or not a request signal for communication information is present, determining whether or not the amount of charges received by a touch screen is at a predetermined threshold or higher; as a result of the checking, when the request signal for the communication information is found to be present, detecting supplied to at least one of a wireless communication unit and transmission and reception power for the communication information. In addition, if the amount of charges received by the touch screen at the predetermined threshold or higher, determining a SAR corresponding to the detected power, and controlling at least one of the power supplied to the wireless communication unit and the transmission and reception power for the communication information. Accordingly, at least one of the power supplied to the wireless communication unit and the transmission and reception power for communication information becomes a predetermined value or lower based on the determined SAR

In accordance with yet another aspect of the present disclosure, a method for controlling communication power in an electronic device includes checking whether or not a request signal for communication information is present, increasing a sensitivity of a response to an input signal received by a touch screen if the request signal for the communication information is found to be present, determining whether or not an amount of charges corresponding to a predetermined threshold area of the touch screen has changed compared to the amount of charges corresponding to the area of the touch screen, detecting power supplied to at least one of a wireless communication unit and transmission and reception power for the communication information if the changed amount of charges is determined to be a change in the amount of charges corresponding to the threshold area, and controlling at least one of the power supplied to the wireless communication unit and the transmission and reception power for the communication information so that the at least one of the power supplied to the wireless communication unit and the transmission and reception power for the communication information becomes a predetermined value or lower if the detected power is at predetermined power threshold or higher.

### BRIEF DESCRIPTION OF THE DRAWINGS

The above features and advantages of the present disclosure will become more apparent to a person of ordinary skill in the art from the following detailed description in conjunction with the accompanying drawings, in which:

FIG. 1 is a diagram schematically illustrating the configuration of a mobile terminal according to various embodiments of the present disclosure;

FIG. 2 is a diagram illustrating the configuration of the control unit of the mobile terminal according to various embodiments of the present disclosure;

FIG. 3 is a diagram illustrating an example the radiation of energy of a mobile terminal according to various embodiments of the present disclosure;

FIG. 4 is a flowchart illustrating controlling communication power of a mobile terminal according to various embodiments of the present disclosure;

FIG. 5 is a flowchart illustrating controlling communication power of a mobile terminal according to various embodiments of the present disclosure;

FIG. 6 is a flowchart illustrating controlling communication power of a mobile terminal according to various embodiments of the present disclosure; and

FIG. 7 is a flowchart illustrating controlling communication power of a mobile terminal according to various embodiments of the present disclosure.

### DETAILED DESCRIPTION

Embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring appreciation of the subject matter of the present disclosure by a person of ordinary skill in the art.

An artisan is to understand that the singular forms “a,” “an,” and “the” include plural references unless the context clearly dictates otherwise. Thus, for example, reference to “a component surface” includes reference to one or more of such surfaces.

By the term “substantially” an artisan is to understand that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. The

Furthermore, it is to be understood that all detailed descriptions listing specific embodiments in addition to the principle and aspects of embodiments are intended to include the structural and functional equivalents of such matters. Furthermore, it should be understood that the equivalents include equivalents to be developed in the future, that is, all devices invented to perform the same function regardless of their configurations, in addition to known equivalents.

Accordingly, it should be understood that block diagrams shown in the drawings are indicative of a conceptual viewpoint of an exemplary circuit that materializes the principle of the present invention. Likewise, it should be understood that all flowcharts, state change diagrams, and pseudo code may be substantially represented in computer-readable media and may be indicative of various processes that are executed by computers or processors regardless of whether the computers or processors are evidently illustrated. The functions of processors or the functions of various devices illustrated in the drawings that include function blocks illustrated as a similar concept may be provided by the use of hardware capable of executing software in addition to dedicated hardware. When being provided by a processor, the function may be provided by a single dedicated processor, a single sharing processor, or a plurality of separated processors, and some of them may be shared.

Furthermore, a processor, controller, or a term suggested as a similar concept thereof, although it is clearly used, should not be construed as exclusively citing hardware having the ability to execute software, but should be construed as implicitly including Digital Signal Processor (DSP) hardware, or ROM, RAM, or non-volatile memory for storing software without restriction. The processor, controller, or term may also include known other hardware.

Furthermore, terms or words used in this specification and the claims should not be construed as having common or dictionary meanings, but should be construed as having meanings and concepts that comply with the technical spirit of the present invention based on the principle that the inventors may appropriately define the concepts of the terms in order to best describe his or her invention

Furthermore, an electronic device according to an embodiment of the present invention may include a mobile phone, a smart phone, a laptop computer, a terminal for digital broadcasting, Personal Digital Assistants (PDA), a Portable Multimedia Player (PMP), or a navigator. A mobile terminal 100, as an embodiment of the electronic device, is described as an example, for convenience of description. It is to be noted that embodiments of the present invention to be described later is not limited to the mobile terminal 100.

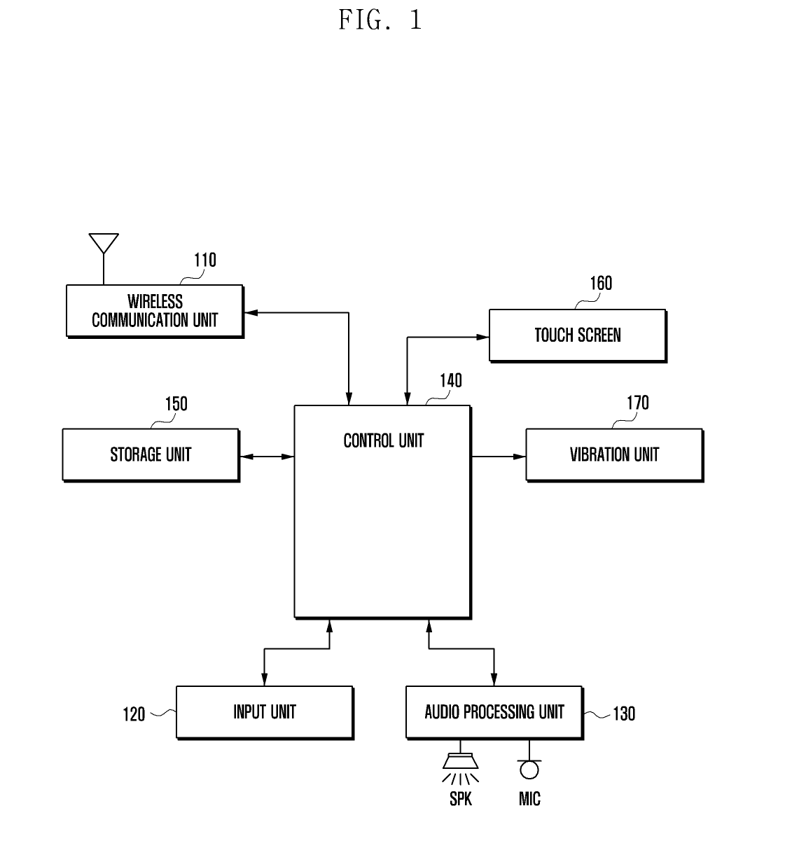

FIG. 1 is a diagram schematically illustrating the configuration of a mobile terminal according to an embodiment of an electronic device 100. The mobile terminal 100 may include a wireless communication unit 110, an input unit 120, an audio processing unit 130, a control unit 140, a storage unit 150, a touch screen 160, and a vibration unit 170. A mobile terminal having elements more than or less than the elements of FIG. 1 may be implemented.

The wireless communication unit 110 is a communication module configured to support mobile communication service for the mobile terminal 100 and includes hardware circuitry such as a transmitter, receiver or transceiver and antenna. The wireless communication unit 110 sets up a communication channel with a mobile communication system. To this end, the wireless communication unit 110 may include a radio frequency transmitter configured to perform up-conversion and amplification on the frequency of a transmitted signal and a receiver configured to perform low-noise amplification on a received signal and down-conversion on the frequency of the signal.

The wireless communication unit 110 may include one or more modules configured to enable wireless communication between the mobile terminal 100 and a wireless communication system or between the mobile terminal 100 and a network in which another mobile terminal 100 is placed. For example, the wireless communication unit 110 may include a broadcasting reception module, a mobile communication module, a wireless Internet module, a short-distance communication module, and a location information module.

The wireless communication unit 110, in accordance with an embodiment of the present invention, checks whether a request signal for communication information from the mobile terminal 100 is present or not. The communication information may include information about the transmission and reception of data, call request information, text message information, and video request information. As a result of the check for the presence of a request signal, if the request signal for communication information is found to present, the wireless communication unit 110 transfers corresponding information to the control unit 140.

Furthermore, when a response to the request signal for communication information is generated, the wireless communication unit 110 in accordance with an embodiment of the present invention may transfer status information about “on the line” or the transmission and reception of a message to the control unit 140. Furthermore, if a change of communication transmission and reception according to a temporal or spatial change of the mobile terminal 100 is larger than a certain amount, the wireless communication unit 110 may transfer corresponding status information to the control unit 140.

With continued reference to FIG. 1, the input unit 120 includes a plurality of input keys and function keys configured to receive numerical or alphabetical information and to configure a variety of types of functions. The function keys may include direction keys, side keys, and shortcut keys configured to perform specific functions. Furthermore, the input unit 120 generates key signals related to user configurations and control of the functions of the mobile terminal 100, and transfers the key signals to the control unit 140.

An artisan understands and appreciates that the input unit is not limited to physical keys, and the input unit could be a touchscreen, or part of the touchscreen 160 with soft and/or virtual keys.

The audio processing unit 130 may include a speaker SPK configured to output an audio signal transferred by the control unit 140 and a microphone MIC configured to collect audio signals when a specific application of the mobile terminal 100 is activated. The audio processing unit 130 may output audio signals received through the wireless communication unit 110. The audio processor may also output audio signals from songs stored on the storage unit

According to an embodiment of the present invention, the audio processing unit 130 may transfer information related to SAR with respect to a sudden change of emitted electromagnetic waves based on a temporal or spatial change of the mobile terminal 100, and may generate an alarm.

The control unit 140, which comprises hardware circuitry configured for operation, performs a support role so that an initialization process is performed by controlling power supplied to the elements of the mobile terminal 100, and may control the elements when the initialization process is completed.

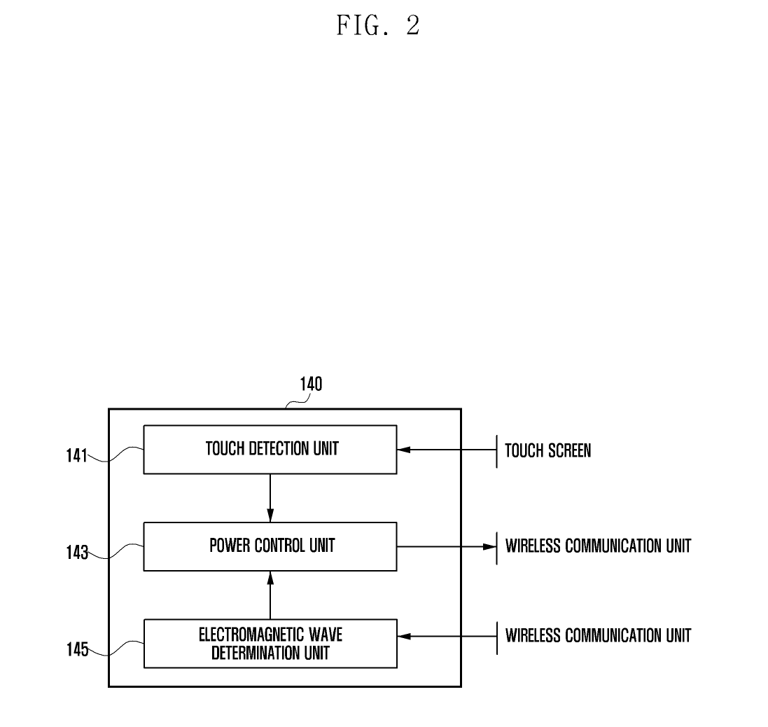

FIG. 2 is a diagram illustrating one possible configuration of the control unit 140 of the mobile terminal according to an embodiment of the electronic device. As illustrated in FIG. 2, the control unit 140 may include a touch detection unit 141, a power control unit 143, and an electromagnetic wave determination unit 145. In accordance with an embodiment of the present invention, the control unit 140 receives corresponding status information when the wireless communication unit 110 checks that a request signal for communication information from the mobile terminal 100 is present. Furthermore, the control unit 140 may receive a communication information request response signal or status information according to a temporal or spatial change of the mobile terminal 100 from the wireless communication unit 110.

The control unit 140, in accordance with an embodiment of the present invention, is configured to check whether or not a “change signal” is received from the touch screen 160 based on received status information. The touch detection unit 141 of the control unit 140 receives a change signal that is generated when the amount of charges received by the touch screen 160 is a predetermined threshold or higher. In response to the change signal, the control unit 140 may recognize that a user's selection input is inputted to the mobile terminal 100.

Furthermore, the touch detection unit 141 may receive a user's selection input according to a resistive type detection, an ultrasonic type detection, an infrared type detection, or an optical type detection in addition to a capacitive type detection that may be adopted by the touch screen 160 that is configured to check whether a user's selection is present or not when the amount of charges has changed.

In accordance with an embodiment of the present invention, when the touch detection unit 141 receives a change signal according to a user's input, the power control unit 143 may detect power supplied to the wireless communication unit 110, or transmission and reception power for communication information. The power control unit 143 may check whether or not the detected power is at a predetermined power threshold or higher, at which point communication is possible. The power threshold may be a minimum power value that is necessary to send and receive communication information to and from a base station or another mobile terminal 100. Alternatively, the power threshold may be a value including a margin power value that includes a power value of an error range in the minimum power value.

With continued reference to FIG. 2, in accordance with an embodiment of the present invention, the power control unit 143 may increase or decrease at least one of the power supplied to the wireless communication unit 110 and the transmission and reception power for the communication information. Furthermore, if the amount of charges received by the touch screen 160 is at predetermined threshold or higher, the power control unit 143 may control at least one of the power supplied to the wireless communication unit 110 and the transmission and reception power for the communication information so that the at least one of the power supplied becomes a predetermined threshold or lower.

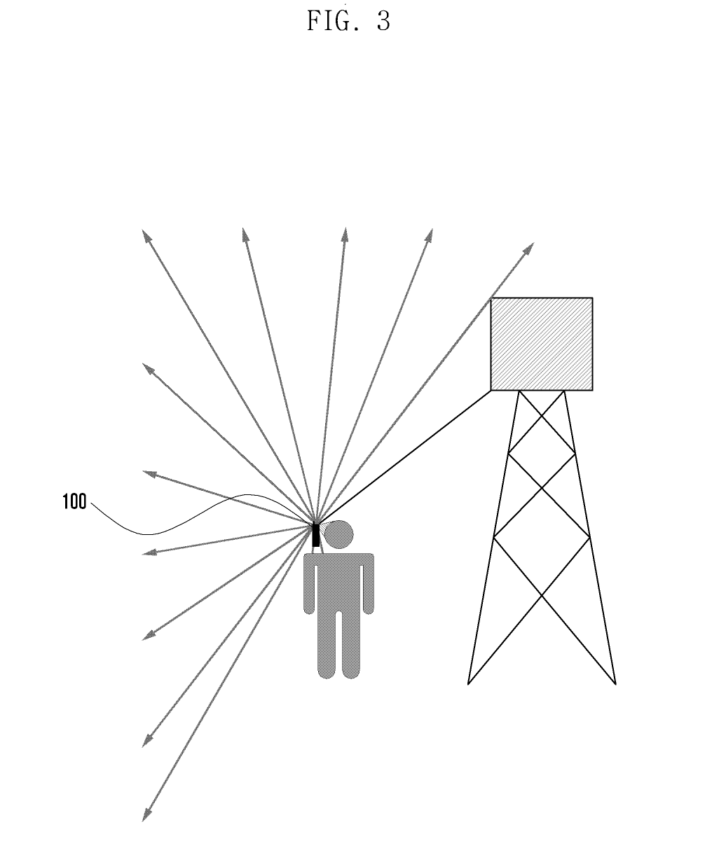

With reference to FIG. 3, in accordance with an embodiment of the present invention, the electromagnetic wave determination unit 145 may determine a SAR corresponding to the detected power. In this case, as illustrated in FIG. 3, the SAR means the degree that electromagnetic waves emitted from the mobile terminal 100 are absorbed by the human body. Electromagnetic waves may have harmful effects on the human body, and the amount of waves being absorbed may be determined using methods to be described herein after.

A method of determining SAR may be performed using a Specific Anthropomorphic Mannequin (SAM) using a big plastic human head model filled with liquid when a test is performed.

Furthermore, a method of determining SAR is a simulation approach to the mobile terminal 100 when a test is performed, and may be performed by dividing the size of the human body into a specific number (e.g., 10) and determining the absorption of electromagnetic waves based on the SAM. In this method, the SAR may be determined in the state in which the size of the human body is divided into a 5-year-old girl, a 6-year-old boy, an 8-year-old girl, and a grown-up woman, for example.

Furthermore, in accordance with an embodiment of the present invention, a method of determining SAR may include executing a previously stored application or program capable of determining SAR and determining the SAR. In other words, the method of determining SAR may include measuring the transmission and reception sensitivity of the wireless communication unit 110 and determining a Received Signal Strength Indication (RSSI) value.

Furthermore, in accordance with an embodiment of the present invention, an SAR corresponding to the power source of the mobile terminal 100 or power supplied to the wireless communication unit 110 or transmission and reception power for communication information may be previously produced in a table form and stored in the storage unit 150. Furthermore, a SAR computed using the aforementioned test may be previously produced in a table form and stored in the storage unit 150.

With reference again to FIG. 2, the electromagnetic wave determination unit 145 may detect power supplied to the wireless communication unit 110 of the mobile terminal 100 or transmission and reception power for communication information, and may determine and detect a corresponding SAR with reference to the previously stored table.

For example, if the detected SAR exceeds a reference value, the power control unit 143 may reduce at least one of the power supplied to the wireless communication unit 110 of the mobile terminal 100 and the transmission and reception power for the communication information so that the at least one becomes the reference value or lower.

The storage unit 150, which a non-transitory storage, may store applications for functions and operations according to the various embodiments, applications for playing back a variety of types of stored files, and a key map or menu map for operating the touch screen 160. In this case, each of the key map and the menu map may have various types of forms.

For example, the key map may be a keyboard map, a 3*4 key map, or a QWERTY key map, or may be a control key map for controlling the operation of an application that is now being activated. Furthermore, the menu map may be a control key map for controlling the operation of an application that is now being activated. Furthermore, the menu map may be a menu map for controlling the operation of an application that is now being activated, or may be a menu map having a variety of types of menus, provided by the mobile terminal 100, as items. The storage unit 150 may include a program region and a data region.

The program region may store an Operating System (OS) for booting the mobile terminal 100 and driving the aforementioned elements, an application for playing back a variety of types of files, for example, an application for supporting a call function depending on whether the mobile terminal 100 supports a call function or not, a web browser for accessing an Internet server, an MP3 application for playing back other music sources, an image output application for outputting photos, and an application for playing back moving images, just to name a few non-limiting possibilities.

The data region is a region in which data generated is stored when the mobile terminal 100 is used, and the data region may store phonebook information, at least one icon according to a widget function, and a variety of types of content. Furthermore, if the data region is produced in the touch screen 160, it may store a user input received through the touch screen 160. In accordance with an embodiment of the present invention, the storage unit 150 may include a program for calculating a ratio in which electromagnetic waves are absorbed by the human body.

The touch screen 160 displays information input by a user or information provided to a user in addition to the various menus of the mobile terminal 100. For example, the touch screen 160 may provide a variety of types of menus according to the use of the mobile terminal 100, for example, a standby screen, a menu screen, a message writing screen, and a call screen. The touch screen 160 may be embodied as a Liquid Crystal Display (LCD) or an Organic Light Emitted Diode (OLED), and may be included in the input unit. Furthermore, the touch screen 160 may include a touch sensor disposed in a display panel state. The mobile terminal 100 may provide a variety of types of menu screens that may be performed based on the touch screen 160 depending on the support of the touch screen 160.

In accordance with an embodiment of the present invention, the touch screen 160 can detect an input event by external object, such a human's finger. For example, the touch screen 160 can recognize an external object by electromagnetic induction.

In accordance with an embodiment of the present invention, the touch screen 160 can include capacitive touch panel and capacitive touch panel controller. The capacitive touch panel controller can supply an amount of charges to the capacitive touch panel. The capacitive touch panel includes a transmit electrode that transmits a constant amount of charges and a receive electrode. The receive electrode can receive a constant amount of charges transmitted from the transmit electrode when no external object is near to the touch screen 160. If an external object, such as a human's finger, is close to the touch screen 160, an amount of charges transmitted by the transmit electrode is divided into the external device and the receive electrode. For example, an amount of charges value transmitted by the transmit electrode is 2.0V before the external object is near to the touch screen 160. And then, an amount of charges value 2.0V received by receive electrode is changed to 0.5V or 0.01V by being transmitted to the external object in a part voltage of the 2.0V.

In accordance with an embodiment of the present invention, when the wireless communication unit 110 checks a request signal for communication information, the touch screen 160 may determine whether or not the amount of charges reaches a predetermined threshold or higher. Furthermore, the touch screen 160 may increase the sensitivity of a response to an input signal that is received when a request signal for communication information is checked. Descriptions of the determination of the amount of changes that have changed and an increase in the sensitivity of a response from the touch screen 160 are the same as those described above.

In accordance with an embodiment of the present invention, the touch screen 160 may display information about SAR. This may include displaying the information obtained through an application or a separate program, and may also include displaying the information in response to a user's selection.

With reference to FIG. 1, the vibration unit 170 performs a variety of types of vibration under the control of the control unit 160. To this end, the vibration unit 170 may include at least one vibration motor (not shown). The vibration unit 170 may receive a call signal in silent vibration mode or may be activated when an alarm time is reached, depending on user setting.

In accordance with an embodiment of the present invention, when the mobile terminal 100 experiences a spatial change in a closed space or subway and thus electromagnetic waves are suddenly changed, the vibration unit 170 may generate vibration by transferring information related to SAR. Thus, the mobile terminal is providing a warning that SAR has changed in response to a change of the electromagnetic waves.

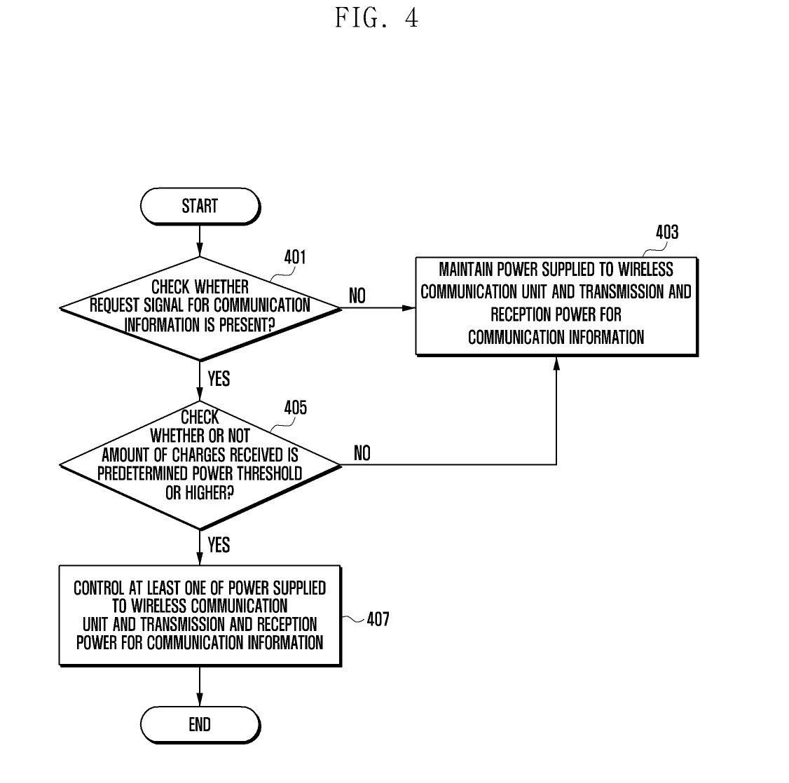

FIG. 4 is a flowchart illustrating one non-limiting example of the operation of controlling communication power of the mobile terminal 100, that is, an embodiment of the electronic device. At operation 401, the wireless communication unit 110 checks whether or not a request signal for communication information is present. The communication information may include a data request signal or a call request signal, such as described above.

As a result of the check by the wireless communication unit 110 at operation 401, if the request signal for communication information is not present and the wireless communication unit 110 is in the idle state, then at operation 403 the control unit 140 maintains the power supplied to the wireless communication unit 110 and transmission and reception power for the communication information. If the wireless communication unit 110 maintains the power as described above, a base station may have minimum transmission and reception power when performing transmission and reception with the wireless communication unit 110 in order to check information about the location of the mobile terminal 100.

However, as a result of the check by the wireless communication unit 110 at operation at 401, if a request signal for communication information is present, the wireless communication unit 110 transfers corresponding information to the control unit 140. When the information is received, the control unit 140 may activate the selection input reception of the touch screen 160.

Thereafter, at operation 405, the touch screen 160 checks whether or not the amount of charges received is a predetermined threshold or higher. If it is determined that as a result of the check at operation 405, the amount of charges received is found to be the predetermined threshold or higher, then at operation 407 the touch screen 160 transfers corresponding information to the control unit 140. The control unit 140 receives information about the amount of charges from the touch screen 160, and may control power supplied to at least one of the wireless communication unit 110 and transmission and reception power for the communication information.

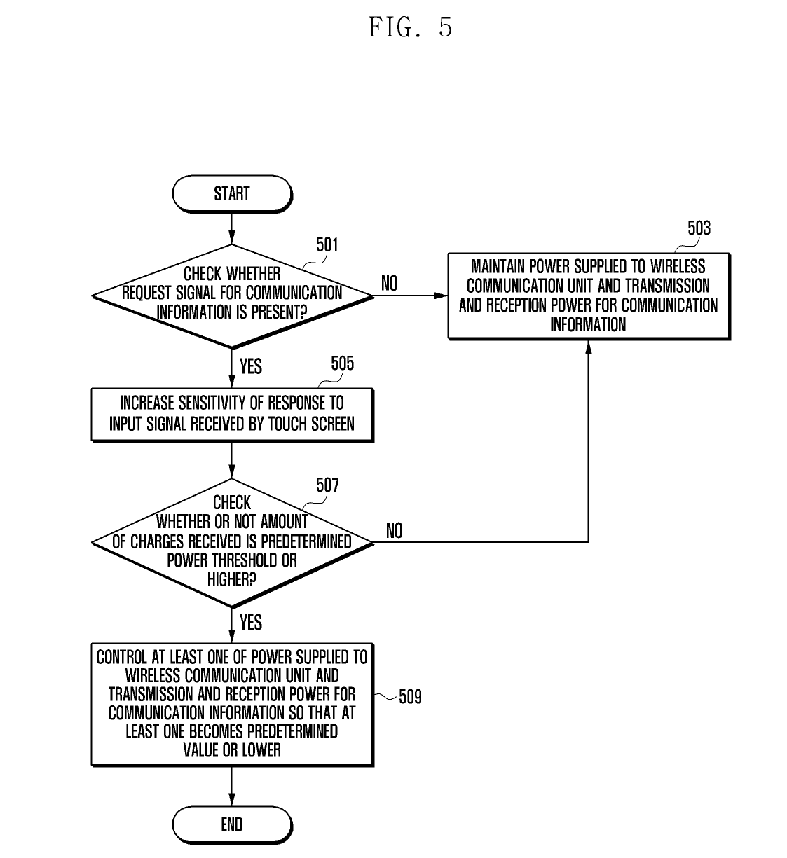

FIG. 5 is a flowchart illustrating a non-limiting example of the operations of controlling communication power of the mobile terminal 100.

At operation 501, the wireless communication unit 110 checks whether or not a request signal for communication information is present. The communication information may include a data request signal or a call request signal as described above. As a result of the check by the wireless communication unit 110 at operation 501, if a request signal for communication information is present and the wireless communication unit 110 is in an idle state, then at operation 503 the control unit 140 maintains power supplied to the wireless communication unit 110 and transmission and reception power for the communication information. If the wireless communication unit 110 maintains the power as described above, a base station may have minimum transmission and reception power when performing transmission and reception with the wireless communication unit 110 in order to check information about the location of the mobile terminal 100.

However, as a result of the check by the wireless communication unit 110 at operation at operation 501, a request signal for communication information is present, then at operation 505 the touch screen 160 may increase the sensitivity of a response to an input signal. This increase in sensitivity may include increasing a predetermined minimum amount, a minimum change, or the amount of a response to specific pressure that may be recognized by the touch screen 160.

If a request signal for communication information is found to be present, the wireless communication unit 110 transfers corresponding information to the control unit 140. Thereafter, at operation 507, the touch screen 160 checks whether or not the amount of charges received constitutes a predetermined threshold or higher.

As a result of the check operation 507, the amount of charges received is found to be the predetermined threshold or higher, then at operation 509, the control unit 140 may reduce at least one of the power supplied to the wireless communication unit 110 or the power for the communication information. For example, the control unit 140 may control at least one of the power supplied to the wireless communication unit 110 and the transmission and reception power for the communication information so that the at least one of the power supplied to the wireless communication unit 110 and the transmission and reception power becomes a predetermined value or lower.

In this case, the predetermined value may mean a minimum power value at which the mobile terminal 100 may be controlled or at which the wireless communication unit 110 may be controlled and communicated, that is, the wireless communication unit 110 may be driven, or a value in which an error range value has been added to the minimum power value.

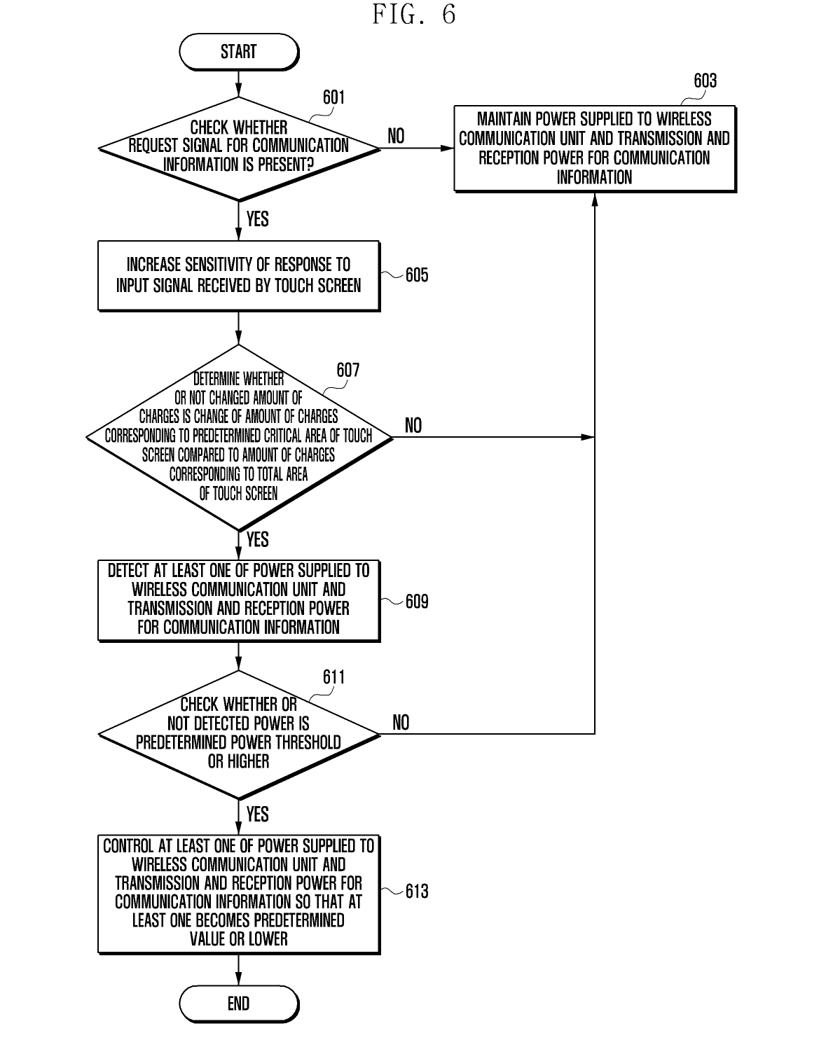

FIG. 6 is a flowchart illustrating a non-limiting example of an operation for controlling communication power of a mobile terminal, that is, an embodiment of the electronic device 100.

At operation 601, the wireless communication unit 110 checks whether or not a request signal for communication information is present. The communication information may include a data request signal or a call request signal, as described above.

As a result of the check the wireless communication unit 110 at operation 601, a request signal for communication information is not present and the wireless communication unit 110 is in an idle state, then at operation 603 the control unit 140 maintains power supplied to the wireless communication unit 110 and transmission and reception power for the communication information. If the wireless communication unit 110 maintains the power as described above, a base station may have minimum transmission and reception power when performing transmission and reception with the wireless communication unit 110 in order to check information about the location of the mobile terminal 100.

As a result of the check by the wireless communication unit 110 at operation 601, if a request signal for communication information is present, then at operation 605 the touch screen 160 may increase the sensitivity of a response to an input signal. This increased sensitivity may include increasing a predetermined minimum amount, a minimum change, or the amount of a response to specific pressure that may be recognized by the touch screen 160.

At operation 607, the touch screen 160 determines whether or not the changed amount of charges is a change of the amount of charges corresponding to a predetermined threshold area of the touch screen 160, compared to the amount of charges corresponding to the total area of the touch screen 160. The predetermined threshold area of the touch screen 160 can be changed and determined by user of the mobile device 100. For example the predetermined threshold area can be 1 cm×1 cm. In an exemplary case, the amount of charges corresponding to the total area whose width is 10 cm×10 cm can be 10 C (coulomb) or 1V. And the amount of charges corresponding to a predetermined threshold area whose width is 1 cm×1 cm can be 0.1 C or 0.01V.

This operation may include determining whether or not charges corresponding to the total area of the touch screen 160 are changed when a user approaches the touch screen 160 of the mobile terminal 100. This operation may also include determining the area of the human body that comes in contact with the mobile terminal 100. As a result of the determination at operation 607, the amount of charges corresponding to the predetermined threshold area is determined to have changed compared to the amount of charges corresponding to the total area of the touch screen 160, then at operation 609 the control unit 140 detects power supplied to at least one of the wireless communication unit 110 and transmission and reception power for the communication information. A method of detecting the power is the same as that described above, and thus a description thereof is omitted.

At operation 611, the control unit 140 checks whether or not the detected power is at a predetermined power threshold or higher. In this case, the predetermined power threshold may include a power value at which the wireless communication unit 110 is capable of transmission and reception as described above.

As a result of the check at operation 611, the detected power of the wireless communication unit 110 reaches the predetermined power threshold or higher, then at operation 613 the control unit 140 may control at least one of the power supplied to the wireless communication unit 110 and the transmission and reception power for the communication information so that the at least one of the power supplied to the wireless communication unit 110 and the transmission and reception power for the communication information becomes a predetermined value or lower.

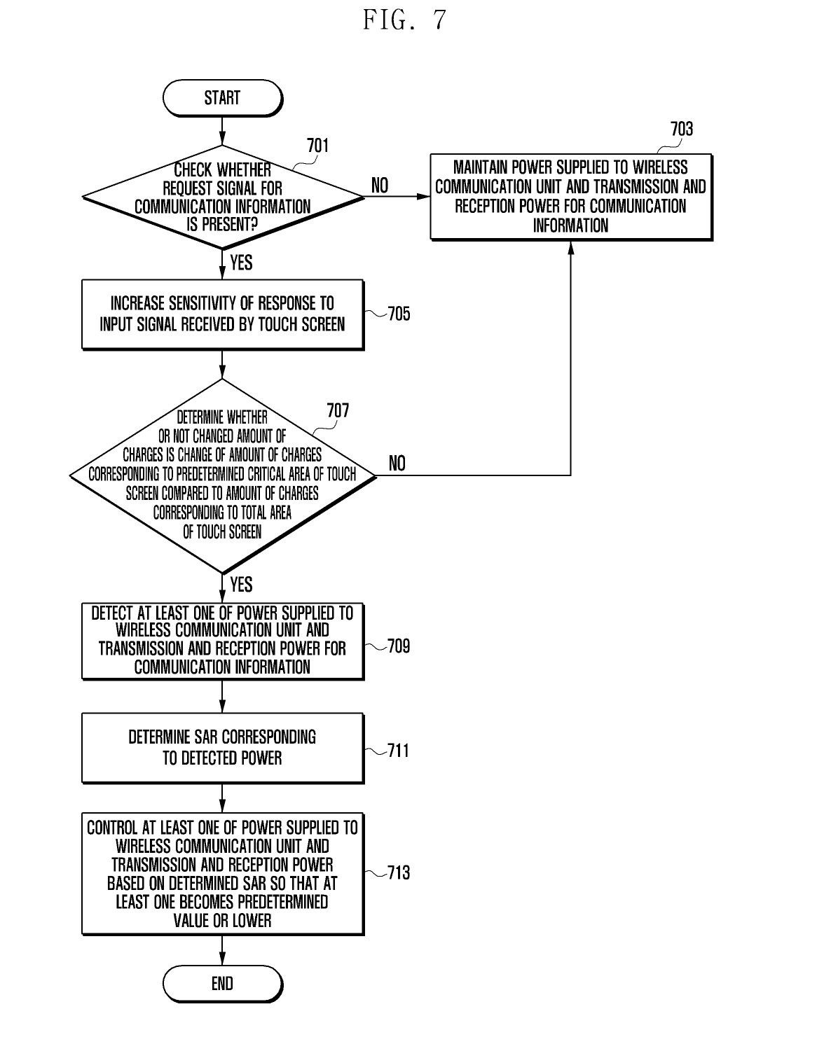

FIG. 7 is a flowchart illustrating a non-limiting example of an operation for controlling communication power of the mobile terminal 100.

At operation 701, the wireless communication unit 110 checks whether or not a request signal for communication information is present. The communication information may include a data request signal or a call request signal, as described above.

As a result of the check by the wireless communication unit 110, if a request signal for communication information is not present and the wireless communication unit 110 is in an idle state, the control unit 140 maintains power supplied to the wireless communication unit 110 and transmission and reception power for the communication information at operation 703. If the wireless communication unit 110 maintains the power as described above, a base station may have minimum transmission and reception power when performing transmission and reception with the wireless communication unit 110 in order to check information about the location of the mobile terminal 100.

However, as a result of the check the wireless communication unit 110 at operation 701, if a request signal for communication information is present, then at operation 705 the touch screen 160 may increase the sensitivity of a response to an input signal. This increased sensitivity may include increasing a predetermined minimum amount, a minimum change, or the amount of a response to specific pressure that may be recognized by the touch screen 160.

If the request signal for the communication information is determined to be present, the wireless communication unit 110 transfers corresponding information to the control unit 140. When the information is received, the control unit 140 may activated the selection input reception of the touch screen 160. Thereafter, at operation 707, the touch screen 160 checks whether or not the amount of charges received is a predetermined threshold or higher.

If, as a result of the check at operation 707, the amount of charges received is found to be the predetermined threshold or higher, the touch screen 160 transfers corresponding information to the control unit 140. When the amount of charges corresponding to a predetermined threshold area of the touch screen 160 is changed compared to the total area of the touch screen 160, then at operation 709 the control unit 140 detects at least one of power supplied to the wireless communication unit 110 and transmission and reception power for the communication information. A method of detecting the power is the same as that described above, and thus a description thereof is omitted.

At operation 711, the control unit 140 determines an SAR corresponding to the detected power.

A method of determining the SAR is the same as that described above, and thus a description thereof is omitted. At operation 713, the control unit 140 may control at least one of the power supplied to the wireless communication unit 110 and the transmission and reception power based on the determined SAR so that the at least one becomes a predetermined value or lower.

The electronic device according to at least one embodiment of the present invention relates to the method and apparatus for controlling communication power, which are capable of lowering SAR by controlling the output of a mobile terminal when the SAR exceeds a standard.

Furthermore, the electronic device according to at least one embodiment of the present invention relates to a method and apparatus for controlling communication power, which are capable of lowering SAR regardless of the size of a mobile terminal.

The apparatuses and methods of the disclosure can be implemented in hardware, and in part as firmware or as software or computer code in conjunction with hardware that is stored on a non-transitory machine readable medium such as a CD ROM, a RAM, a floppy disk, a hard disk, or a magneto-optical disk, or computer code downloaded over a network originally stored on a remote recording medium or a non-transitory machine readable medium and stored on a local non-transitory recording medium for execution by hardware such as a processor, so that the methods described herein are loaded into hardware such as a general purpose computer, or a special processor or in programmable or dedicated hardware, such as an ASIC or FPGA. As would be understood in the art, the computer, the processor, microprocessor, controller, control unit or other programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” “controller”, or “control unit” or “microcontroller” constitute hardware in the claimed disclosure that contain circuitry that is configured for operation with software or firmware. Under the broadest reasonable interpretation, the appended claims constitute statutory subject matter in compliance with 35 U.S.C. §101.

The definition of the terms “unit” or “module” as referred to herein is to be understood as constituting hardware circuitry such as a processor or microprocessor configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and does not constitute software per se or pure software. Furthermore, the embodiments disclosed in this specification and drawings propose only specific examples in order to easily describe the contents of the present invention and help with understanding, and the embodiments are not intended to restrict the scope of the appended claims. Accordingly, it should be understood that all modifications or variations derived based on the technical spirit of the present disclosure in addition to the disclosed embodiments should be construed as being included in the claimed invention.

What is claimed is:

1. A method for controlling communication power in an electronic device, the method comprising:
checking by a wireless communication unit whether or not a request signal for communication information is present;
when the request signal for the communication information is found to be present, determining whether or not an amount of charges received by a touch screen is at least equal to a predetermined threshold or higher; and
controlling power supplied to at least one of a wireless communication unit and transmission and reception power for the communication information based on a result of the determination.

2. The method of claim 1, further comprising:
when the request signal for the communication information is found to be present, increasing a sensitivity of a response to an input signal received by the touch screen.

3. The method of claim 2, wherein the controlling of the at least one of the power supplied to the wireless communication unit and the transmission and reception power for the communication information comprises controlling the power supplied to at least one of (1) the wireless communication unit and (2) the transmission and reception power for the communication information, so that the power is supplied at a predetermined value or lower when the amount of charges received by the touch screen is at least equal to the predetermined threshold or higher.

4. The method of claim 2, wherein the determining of whether or not the amount of charges received by the touch screen is at least equal to the predetermined threshold or higher comprises:
determining whether or not there is a changed amount of charges received by the touch screen corresponding to a predetermined threshold area, as compared to an amount of charges corresponding to another area of the touch screen.

5. The method of claim 4, further comprising:
detecting at least one of the power supplied to the wireless communication unit and the transmission and reception power for the communication information when, as a result of the determination, the changed amount of charges corresponds to a threshold area of the touch screen; and
determining whether or not a detected power is equal to a predetermined power threshold or higher.

6. The method of claim 5, wherein the controlling of the at least one of the power supplied to the wireless communication unit and the transmission and reception power for the communication information comprises controlling at least one of the power supplied to the wireless communication unit and the transmission and reception power for the communication information so that the power is supplied at a predetermined value or lower when, as a result of the determination, the detected power is equal to the predetermined power threshold or higher.

7. The method of claim 1, further comprising:
detecting at least one of the power supplied to the wireless communication unit and the transmission and reception power for the communication information when the amount of charges received by the touch screen is equal to the predetermined threshold or higher;
determining a Specific Absorption Rate (SAR) corresponding to a detected power supplied at least one of the power supplied to the wireless communication unit and the transmission and reception power for the communication information; and
controlling the power supplied to at least one of the wireless communication unit and the transmission and reception power for the communication information at a predetermined value of power or lower based on the determined SAR.

8. The method of claim 7, further comprising displaying information about the SAR.

9. An apparatus for controlling communication power,
a wireless communication unit configured to check for a presence of a request signal for communication information;
a touch screen configured to determine whether or not an amount of charges received is equal to a predetermined threshold or higher than the predetermined threshold when the wireless communication unit identifies a presence of the request signal for the communication information is present; and
a control unit configured to control power supplied to at least one of the wireless communication unit and transmission and reception power for the communication information based on a result of the determination of the amount of charges received.

10. The apparatus of claim 9, wherein when the request signal for the communication information is present the touch screen is further configured to increase a sensitivity of a response to an input signal.

11. The apparatus of claim 10, wherein the control unit is further configured to comprise:
a touch detection unit configured to receive a change signal generated when the amount of charges received by the touch screen is equal to the predetermined threshold or higher; and
a power control unit configured to control the power supplied to at least one of the wireless communication unit and the transmission and reception power for the communication information at a predetermined value or lower.

12. The apparatus of claim 10, wherein the touch screen is further configured to determine whether or not a changed amount of charges corresponds to a predetermined threshold area of the touch screen as compared to an amount of charges corresponding to another area of the touch screen.

13. The apparatus of claim 12, wherein the control unit is further comprises a power control unit configured to detect the power supplied to at least one of the wireless communication unit and the transmission and reception power for the communication information and determine whether or not the detected power is equal to a predetermined power threshold or higher.

14. The apparatus of claim 13, wherein the power control unit is further configured to control the power supplied to at least one of the wireless communication unit and the transmission and reception power for the communication information at a predetermined value or lower when the detected power is equal to the predetermined power threshold or higher.

15. The apparatus of claim 9, wherein the control unit is further comprises:
a power control unit configured to detect the power supplied to at least one of the wireless communication unit and the transmission and reception power for the communication information; and
an electromagnetic wave determination unit configured to determine a Specific Absorption Rate (SAR) corresponding to the detected power.

16. The apparatus of claim 15, wherein the power control unit is further configured to control the power supplied to at least one of the wireless communication unit and the transmission and reception power for the communication information at a predetermined value or lower based on the determined SAR.

17. The apparatus of claim 15, wherein the touch screen displays information about the SAR.
